(19) United States
(12) Patent Application Publication
(10) Pub. No.: US 2007/0174027 A1
(43) Pub. Date: Jul. 26, 2007

(54) Synchronized architectural and structural CAD models

(76) Inventor: Aleksey Moiseyev, Worcester, MA (US)

Correspondence Address: FISH & RICHARDSON P.C., PO BOX 1022, MINNEAPOLIS, MN, 55440-1022, US

(21) Appl. No.: 11/341,229

(22) Filed: Jan. 26, 2006

(51) Int. Cl. G06F 17/50

(52) U.S. Cl. 703/1

(57) ABSTRACT

Methods and apparatus, including computer program products, for providing an architectural computer aided design (CAD) model. A user input selecting an architectural element in the architectural CAD model is received. A structural element is automatically created in a structural CAD model, the structural element based on the selected architectural element. A monitored relationship is automatically established between the architectural element and the structural element.

### BACKGROUND

Architects and structural engineers are jointly involved in designing and developing buildings. Architects are charged with spatial design, and they create drawings that reflect the layout of spatial elements, materials used, and construction details. Structural engineers deal with design of load-bearing elements, which are a subset of total building materials. Frequently, there is iterative design process that happens between architects and structural engineers, as the size and configuration of load-bearing elements either impinges on or is used in the spatial design.

Both architects and engineers use Computer Aided Design (CAD) programs to develop construction drawings. Architects develop architectural design drawings (plans, elevations, sections), and structural engineers develop structural drawings and details. In most designs, many structural and architectural elements are identical but represented in slightly different ways. Columns, for example, will be shown on both structural and architectural drawings. The version shown on the architectural drawings would include any elements designed to conceal or decorate the column, while the structural version would typically only show load-bearing members.

Typically the structural drawings needed for a building's construction documents and the architectural drawings for the same set of documents, are developed by separate teams. However, because of the noted relationship between architectural and structural elements, any change in the layout or the size of a space or a structure has to be reflected in both sets of drawings. Thus, changes made from either the architect's side or structural engineer's side conventional have to be manually tracked and changed by the other. This is both an inefficient and costly process simply in terms of duplication of effort and coordination. Moreover, if a mistake is made in tracking and synchronizing changes, it can have cost and schedule implications during construction.

### SUMMARY

This disclosure generally describes systems, techniques and computer program products for synchronizing architectural and structural CAD models.

In one general aspect, the techniques feature providing an architectural computer aided design (CAD) model. A user input selecting an architectural element in the architectural CAD model is received. A structural element is automatically created in a structural CAD model, the structural element based on the selected architectural element. A monitored relationship is automatically established between the architectural element and the structural element.

The invention can be implemented to include one or more of the following advantageous features. An architectural element is a wall, a floor, a column, a level, or a grid. Automatically determining that a monitored relationship is violated. Allowing a user to resolve the monitored relationship if the monitored relationship is violated. Automatically resolving the monitored relationship if the monitored relationship is violated. The structural element includes a modification of one or more properties of an architectural element. The modification is one or more of: modifying a name of the architectural element, subdividing the architectural element, changing a type of the architectural element, or adding an offset to the position of the architectural element. Creating a structural element includes creating the structural element at a location in the structural model that corresponds to a location in the architectural model. The architectural CAD model and the structural CAD model are part of a common CAD model.

In another general aspect, the techniques feature receiving a user input selecting one of: an architectural element or a structural element. If an architectural element is selected, creating a structural element corresponding to the selected architectural element. If a structural element is selected, creating an architectural element corresponding to the selected structural element. Automatically creating an association between the structural element and the architectural element such that a monitored relationship exists between structural element and the architectural element. And monitoring the monitored relationship.

The invention can be implemented to include one or more of the following advantageous features. Automatically determining that the monitored relationship is violated. Automatically resolving the monitored relationship if the monitored relationship if violated. Modifying a property of one of the structural element and the architectural in accordance to user input; and updating the property maintains the monitored relationship. Updating the property of the other to reflect the modifying.

In another general aspect, the techniques feature creating a relationship between a first property of a first element in a first computer aided design (CAD) model and a second property of a second element in a second CAD model. Violation of the relationship is detected, the violation due to modification of one of the first property or the second property. And automatically modifying one of the first property or the second property to restore the relationship.

The invention can be implemented to include one or more of the following advantageous features. The relationships requires that the first property be equal to the second property. Updating the structural element includes incorporating the geometry of the surface into the structural element.

Implementations of the invention can realize one or more of the following advantages. Sharing the same information with architects and engineers enables the structural and the architectural design and documentation to stay coordinated. Associating the architectural design elements in an architectural CAD model with structure design elements in a structural CAD model gives structural engineers a starting point for their design, based on the architect's design intent. Changes made by the architect or the structural engineer can be monitored which facilitates design coordination and change management.

A copy tool copies elements from one model to another and automatically creates associations between properties of the elements so that changes can be monitored. A coordination tool tracks changes that have occurred when an associated model is reloaded or refreshed, and presents them to the engineer or architect in an orderly way for review. For example, the structural designer is warned that the architect deleted a column enclosure that was associated with one of the engineer's structural columns. The structural designer can then choose to respond to that design change directly in the model or to flag it for further action.

The details of one or more implementations of the invention are set forth in the accompanying drawings and the description below. Other features, aspects, and advantages of the invention will be apparent from the description and drawings, and from the claims.

### DESCRIPTION OF DRAWINGS

FIG. 1 shows a user interface for viewing and manipulating one or more CAD models.

FIG. 2 shows the user interface presenting a plan view.

FIG. 3 is an illustration of associated elements in different CAD models.

FIG. 4 shows a user interface for an interactive copy tool that facilitates copying and monitoring elements in two or more CAD models.

FIG. 5 shows the user interface displaying a plan view augmented with indicators marking elements that have relationships that are being monitored.

FIG. 6 shows the user interface displaying a corresponding model to that illustrated in the plan view of FIG. 2.

FIG. 7 shows a coordination tool for a user of a model containing elements associated with those in the model presented in FIG. 6.

FIG. 8 is a further illustration of the coordination tool for a user of a model containing elements associated with those in the model presented in FIG. 6.

FIG. 9 is a further illustration of the coordination tool for a user of a model containing elements associated with those in the model presented in FIG. 6.

FIG. 10 is a diagram of an interactive system for synchronizing architectural and structural CAD models.

FIG. 11 is a flow diagram illustrating automatic creation of structural elements.

FIG. 12 is another flow diagram illustrating automatic creation of structural elements.

FIG. 13 is a flow diagram illustrating relationship management between CAD models or views.

Like reference symbols in the various drawings indicate like elements.

### DETAILED DESCRIPTION

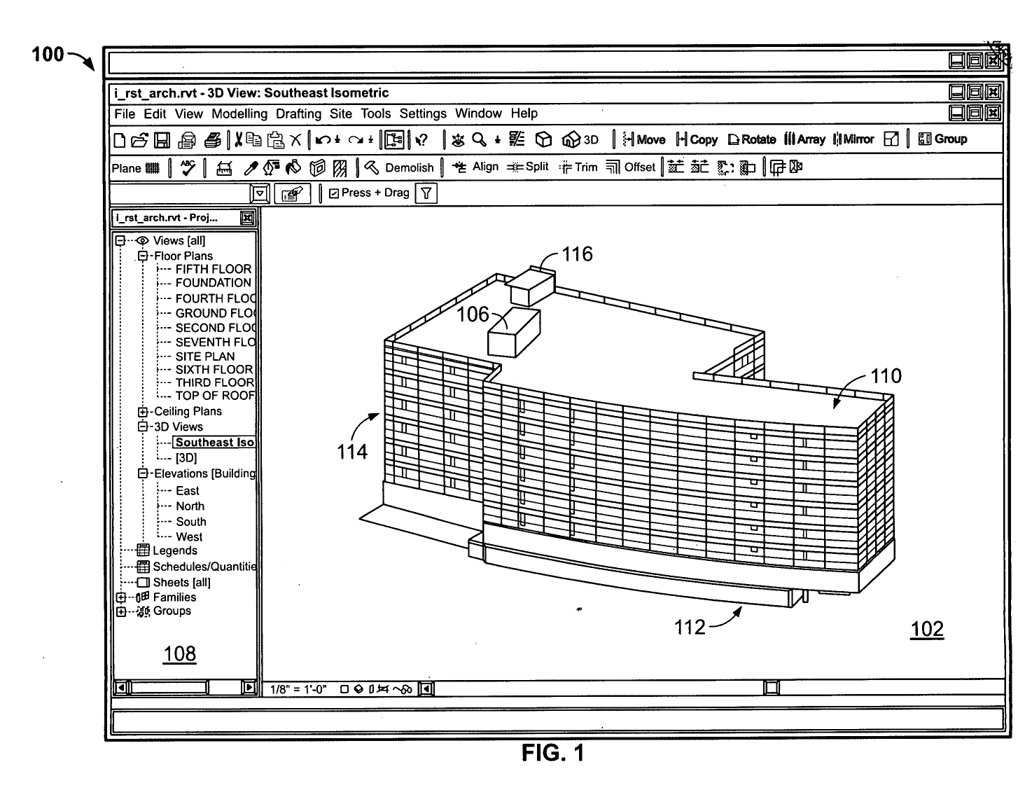

FIG. 1 shows a user interface 100 for viewing and manipulating one or more CAD models. The user interface 100 can be presented by an interactive CAD software application that allows for the viewing, creating, importing, exporting, and modifying of one or multiple CAD models. The same user interface 100 can be used by architects and structural engineers. In one implementation, the software application is Autodesk® Revit® Building, available from Autodesk, Inc. of San Rafael, Calif.

Generally, architects and structural engineers develop separate CAD models of a structure such as a building. Architectural models can serve as the starting point for structural models. A CAD model is one or more CAD models, a view of one or more CAD models, or a combination of these. A CAD model can contain information required to represent one or more architectural and structural elements, or other elements, and relationships between them. For example, a CAD model can store one or more representations (e.g., architectural, structural, analytical) of a CAD model of a building. A CAD model can be stored in one or more files, object-oriented databases, relational databases, distributed objects, combinations of these, or other suitable persistent storage. In one implementation, CAD model files can refer to each other so as to share information. The term “model” as used herein is synonymous with the CAD model's contents.

The user interface 100 illustrated in FIG. 1 can present one or more views of one or more models. A three dimensional (3D) view 102 presents a CAD model of a building. The view 102 can be used to create and modify CAD model elements such as, but not limited to, levels, grids, beams, casework, ceilings, columns, curtain panels, curtain wall mullions, doors, electrical equipment, electrical fixtures, floors, furniture, furniture systems, generic models, lighting fixtures, mechanical equipment, plumbing fixtures, railings, ramps, roofs, specialty equipment, stairs, structural columns, structural foundations, structural framing (e.g., girders, horizontal bracing, joists, kicker bracing, vertical bracing), walls and windows. Moreover, an element can be a combination of elements.

In one implementation and by way of illustration, the user interface 100 includes a panel 108, which allows a user to select views and display one or multiple views in the user interface 100. The view panel 108 includes, but is not limited to, two dimensional (2D) and 3D views, plans, elevations, sectional views, analytical views, and combinations of these. In this example, view 102 presents an exterior view of a building having the following elements: a roof 110, stairwell 116, electrical equipment 106, curtain panels 114 and a foundation 112.

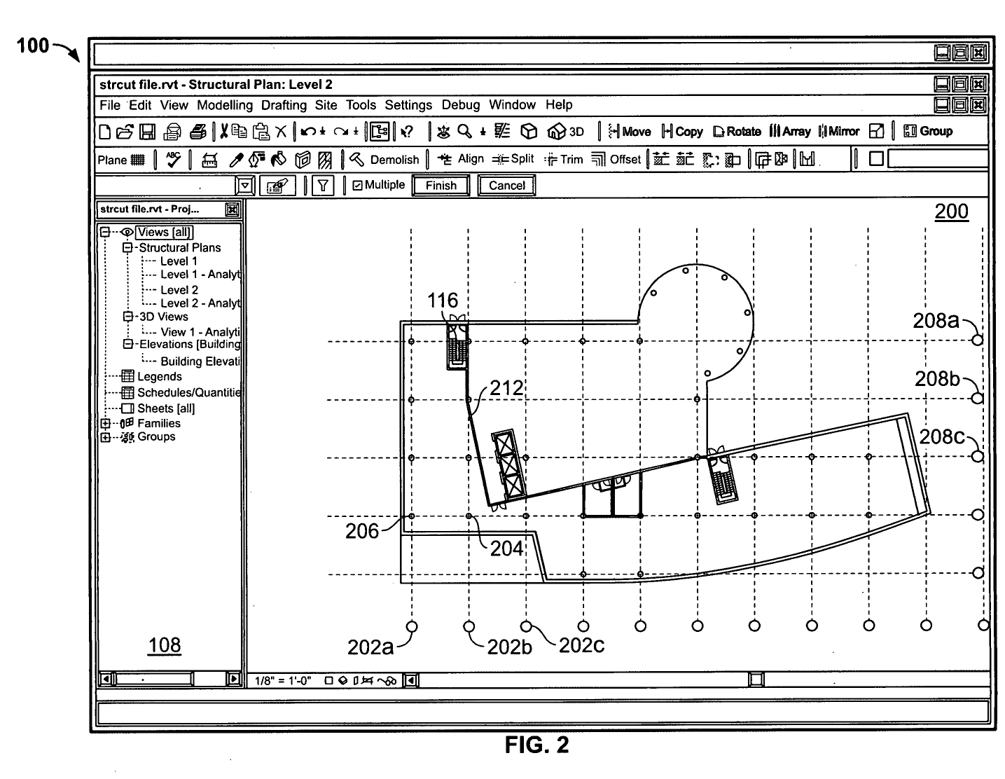

FIG. 2 shows the user interface 100 presenting a plan view 200. The plan view 200 is a 2D overhead view looking down on a horizontal plane. In this illustration, the horizontal plane represents a floor in the building depicted in view 102. The view 200 illustrates a grid composed of horizontal (e.g., 208a, 208b, 208c) and vertical (e.g., 202a, 202b, 202c) grid lines. A grid does not represent a physical entity; it is a drawing aid that provides visual references for positioning and aligning elements. Columns in the plan view 200 are depicted as hollow shapes, such as circles 204 and 206. The stairwell 116 and a wall 212 are also depicted.

Architectural and structural parts of the same project are typically done by different teams working on their own CAD models. Often one discipline's work is based on the work of the other. For example, structural engineers can work from an architectural drawing of a building created from an architectural CAD model to create a structural CAD model of the building. At various points in time the two CAD models ,need to be synchronized to reconcile changes that do not harmonize. For example, elements that are common in both models such as a wall may be in different positions in the models, or the wall may have been deleted from one of the models.

Each CAD model element is associated with one or more properties. A property can be (without limitation), an element type, a number, a set, a string, a vector, an array, a data structure, an object, or a combination of these. A property can include other properties. In one implementation, typical CAD element properties include element type, geometry, location, elevation, weight, cross sectional area, load reactions, openings, and construction materials. Relationships between properties in common for two CAD model elements in different models can be automatically monitored for changes by establishing an association between the CAD model elements.

A relationship describes how one property is related to another for two associated elements. One kind of relationship is an equality relationship which requires a property in two CAD model elements to be equal, such as element type or position. Another kind of relationship is proportional which requires a property in two elements to be in proportion to each other. Other binary relationships such as, but not limited to, greater than, greater than or equal to, less than, less than or equal to are possible. Yet another relationship requires the property in one element to be within a certain “distance” from the property in the other element. Moreover, a relationship can be defined as a Boolean function which evaluates to a true value when the relationship holds, and evaluates to a false value when the relationship is violated (i.e., the relationship no longer holds). Furthermore, if a relationship is violated, current values of monitored elements are stored so that if the same monitored relationship violated a subsequent time, users will receive an additional notice of the violation.

Automatic monitoring of relationships allow users to take action when a required relationship no longer holds. For example, if an architectural model and a structural model corresponding to the architectural model each have a wall in common and the wall's position in one model is changed, a user of the other model can be notified so that appropriate action can be taken, such as mirroring the change. Monitoring relationships between CAD model elements in different models allows different users to easily coordinate their changes through interactive tools and thereby painlessly keep their models synchronized.

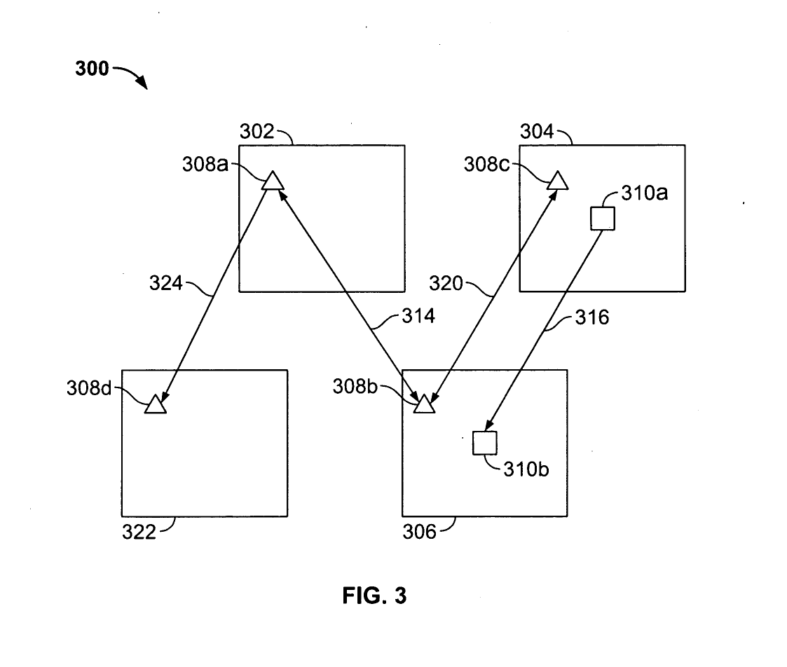

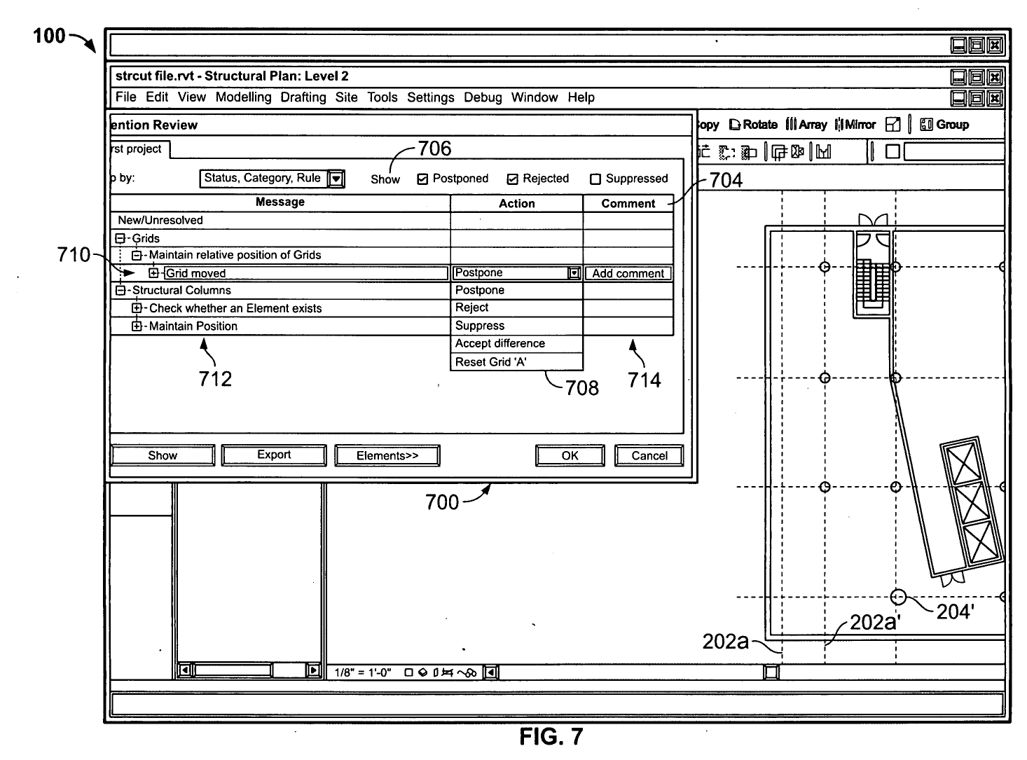

FIG. 3 is an illustration of associated elements in different CAD models. Associating CAD model elements creates a monitored relationship (or “relationship”) between properties of the elements. A monitored relationship is automatically checked at various points in time to determine if the relationship in question has been violated. An association between two CAD model elements in different models can be unidirectional or bidirectional. A unidirectional association is a relationship between a property of a so-called dominant CAD model element in one model and the same property in a so-called subordinate CAD model element in a different model. Changes to the property in the either element that violate the relationship can be manually or automatically rectified by making changes to the subordinate element's properties through the use of a coordination tool which can be used to restore the relationship with the dominant element. (See FIG. 7 below and the accompanying description of the coordination tool.) The user interface 100 can also alert the user of changes in a dominant element which should be coordinated with subordinate element(s). Monitored relationships between elements can be specified or inferred as will be discussed in greater detail below.

By way of illustration, CAD model 304 includes a CAD model element 310a. A corresponding CAD model element 310b belongs to CAD model 306. The element 310b could have been copied from model 304 or created anew in model 306. In one implementation, copying elements from one model to another by default creates the elements at the same spatial location as the corresponding elements in the other model and creates a unidirectional association (e.g., equality relationship) from one or more properties of the copied element (dominant) to one or more properties of the copying element (subordinate). A unidirectional association 316 from element 310a to element 310b is shown. Changes to one or more properties of either element 310a or 310b that violate a relationship can be rectified by a user of model 306 as described below. Another unidirectional association 324 between element 308a in model 302 and 308d in model 322 is also illustrated.

A bidirectional association between two elements means a monitored relationship between one or more properties of the two elements operates in both directions. As with unidirectional relationships, changes to a property either element can cause a violation of a monitored relationship. However, with a bidirectional relationship properties in either element can be changed to restore the relationship.

For example, there is a bidirectional association depicted as 314 between CAD model elements 308a and 308b in different CAD models. A change to one or more properties of one element in one model that violate a relationship between the two elements can be rectified by changing the properties in either element so that the relationship is restored. In another implementation, copying elements from one model to another by default creates the elements at the same spatial location as the corresponding elements in the other model, and creates a bidirectional association from the copied element to the copying element.

Another bidirectional relationship 320 between element 308b in model 306 and element 308c in model 304 is shown. As described above, changes to one or more properties of either element 308b or 308c that violate a relationship between the elements can be manually or automatically rectified through use of a tool. Moreover, if changes to one or more properties of element 308a violate a relationship between 308a and 308b, resolving the violation by changing one or more properties of element 308b may also violate a relationship between elements 308b and 308c. If this was the case, the relationship between elements 308b and 308c may be restored by propagating property changes made to element 308b to element 308c.

Any CAD element property can be associated with another CAD element's property, whether or not the CAD element types are the same or different. In one implementation, the CAD model element types available for associating are described in TABLE 1.

TABLE 1

| ELEMENT | | PROPERTIES | PROPERTIES |
|---|---|---|---|
| CATEGORY | COPY OPTIONS | COPIED | MONITORED |
| Grid | Change name. | Position and | Position, geometry, and |
| | | geometry. | name change. |
| Level | Change name, type, | Position and | Position, elevation, and |
| | and add an offset. | elevation. | name change. |
| Wall | Change name, change | Position, elevation | Position in plan view, |
| | type, add offset, copy | profile, inserts, | name change, top and |
| | inserts, remove | presence of | bottom elevation, |
| | inserts, and copy | required windows | elevation profile, |
| | inserts according to | or other openings, | thickness of core, and |
| | settings. | and the position of | presence and position of |
| | | required windows | required windows or |
| | | or other openings | other openings. |
| | | relative to the wall. | |
| Floor | Change name, change | Position, geometry, | Position, name change, |
| | type, and add offset. | and required | boundary, vertical offset, |
| | | openings. | slope, thickness of core, |
| | | | new, modified or deleted |
| | | | openings. |
| Column | Change name, change | Position, height, | Position in plan view, |
| | type, add offset, and | and other | top and bottom |
| | divide column into | applicable | elevations, type. |
| | several shorter sub- | properties. | |
| | columns by levels and | | |
| | establishing the same | | |
| | monitored | | |
| | relationships for each | | |
| | sub-column. | | |

With reference to TABLE 1, there are five types of CAD model elements whose properties can be associated with like elements in other models: grids, levels, walls (including insets, windows, and other openings), floors, and columns. Other types of CAD model elements are possible. Each element has a default set of properties that can serve as the basis for one or more monitored relationships, whether an association is unidirectional or bidirectional. For example, the default properties of a grid include the grid's position, geometry, and name. If any of these properties is changed such that a relationship is violated, the change(s) can be reported to user(s) so that the appropriate action can be taken. TABLE 1 also includes a Properties Monitored column detailing properties of each type of element that can belong to a monitored relationship.

The other elements in TABLE 1 are as follows. A level is a horizontal line or plane. A level's default monitored properties include the level's position, elevation, and name. A wall's default monitored properties include the wall's position in a plan view, top and bottom elevation, elevation profile, thickness of core, and presence of required windows or other openings. A floor's default monitored properties include the floor's position, boundary, vertical offset, slope, core thickness, and any new, modified or deleted openings. Finally, a column's default monitored properties include the column's position in a plan view, top and bottom elevations, and the column type.

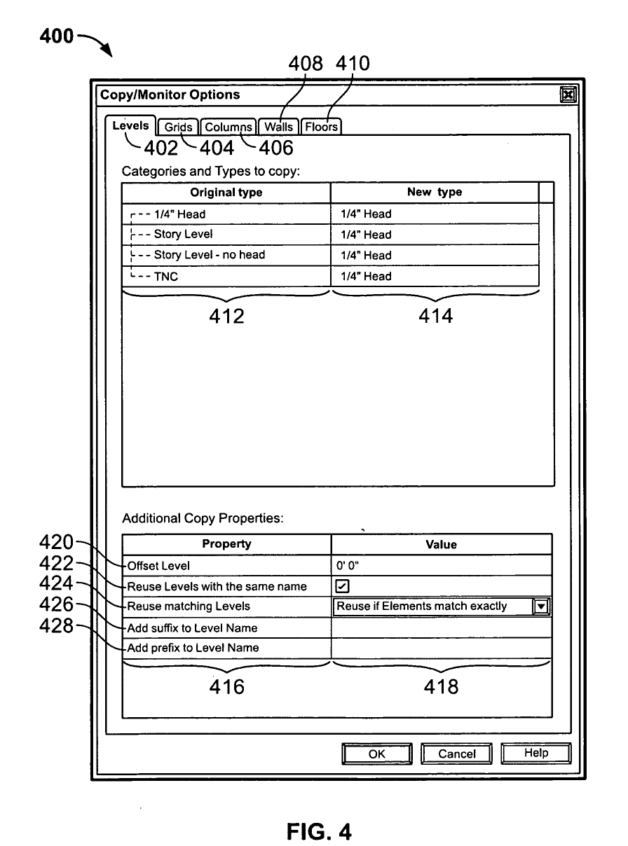

FIG. 4 shows a user interface for an interactive copy tool 400 that facilitates copying and monitoring elements in two or more CAD models. In one implementation, the copy tool 400 allows a user to copy selected elements from one or multiple source models into a destination model, while creating associations and optionally applying changes to the copied elements' properties. In one implementation, the tool 400 also establishes a unidirectional or bidirectional relationship for each element copied. Other tools for creating these relationships are possible.

A user can select one or elements to copy from one or more source models manually, such as by selecting elements with a mouse or other input device, or automatically, such as by specifying elements to copy based on type or property values (e.g., all columns with of a certain height). The user also designates the destination model. The tool 400 includes tabs 402, 404, 406, 408, 410 for each element type that is being copied. Each tab has an associated display of copying options that can be applied to each copied element's properties in the destination model. In one implementation, these options are as described in TABLE 1.

A CAD model element has a type property. In one implementation, types can have subtypes. A source element of a certain subtype when copied can be optionally changed into a destination element having a different subtype. For example, a level element can be one of four subtypes, as indicated in pane 412: ¼″ head, story level, store level without head, and TNC. Each source element of a given subtype can be changed into a new subtype in the destination model. In this example, each of the source subtypes is changed into ¼″ head type in the destination model, as indicated by the New Type pane 414. The new types do not have to be the same and can all be different.

A user can specify other property options by selecting choices in panes 416 and 414. Pane 416 lists properties of the element that can be modified in a copied element. Pane 418 lists corresponding changes (if any) to be applied to the copied element. In this illustration, the level properties that can be changed include an offset level 420. The offset level is a positive or negative amount that can be added to the offset level property of the copied element to compensate for floor finishes (or lack thereof) or other differences in the destination model. In this example, the value of the offset is 0′0″, which means the level will be in the same position in the destination model as the source model.

In one implementation, an option to reuse levels with the same name can be selected. For example, if level with some name should be created in destination model as a result of copy operation but there is a level with this name in a destination model already, a new level will not be created. Instead, the existing level will be moved to a position that corresponds to the position of the level in the source model. In a further implementation, an option to reuse matching levels can be specified. For example, if a level with a given position is created in destination model as a result of a copy operation, for example, but there is an existing level within a given offset in the target model, the new level will not be created. Rather, the existing level will be moved to desired location, renamed as required and monitoring will be set up with this level. These implementations prevent creation of levels with the same names or overlapping levels.

Finally, a level element's name property in the destination model can be changed by adding a suffix 426 or a prefix 428.

Properties that can be changed for other elements are described in Table 1 under the column heading Copy Options. These can be changed by user in tool 400 by selecting the tab (402, 404, 406, 408, 410) corresponding to the type and modifying the properties, as was demonstrated with level elements. In one implementation, all properties of a source element are copied to the destination element (with any optional changes applied). In another implementation, only those properties described in the Properties Copied column of TABLE 1 are copied (with any optional changes applied).

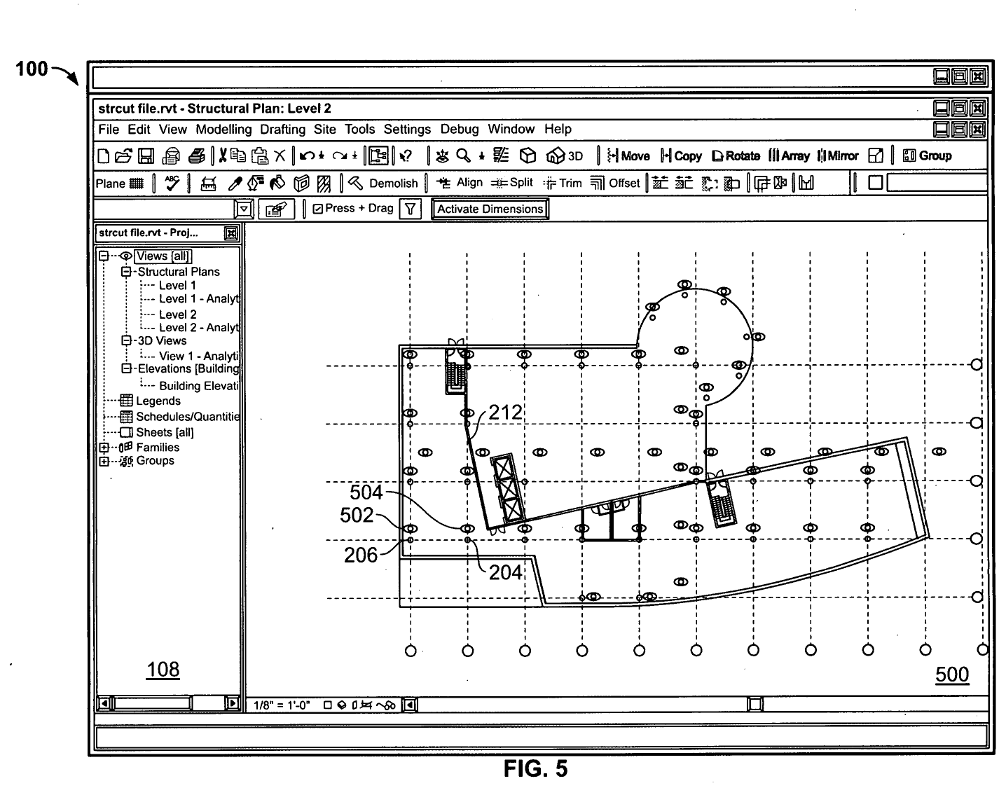

FIG. 5 shows the user interface 100 displaying a plan view 500 augmented with indicators (e.g., 502, 504) marking elements that have relationships that are being monitored. Each indicator is adjacent to a CAD model element that belongs to a unidirectional or bidirectional relationship. By selecting an indicator, such as with a mouse or other input device, a user can discover the type of relationship (including the identification of the other element and model), and in the case of unidirectional relationships, whether the element is dominant or subordinate. Selecting an element or an indicator for the element allows a user to severe the relationship, change the relationship type (assuming the user has permission to do so), or discover whether the relationship is violated. Alternatively, the indicator can change (e.g., change color, animation) to indicate if the relationship is violated. In this illustration, indicators 502 and 504 are adjacent to monitored columns 206 and 204, respectively.

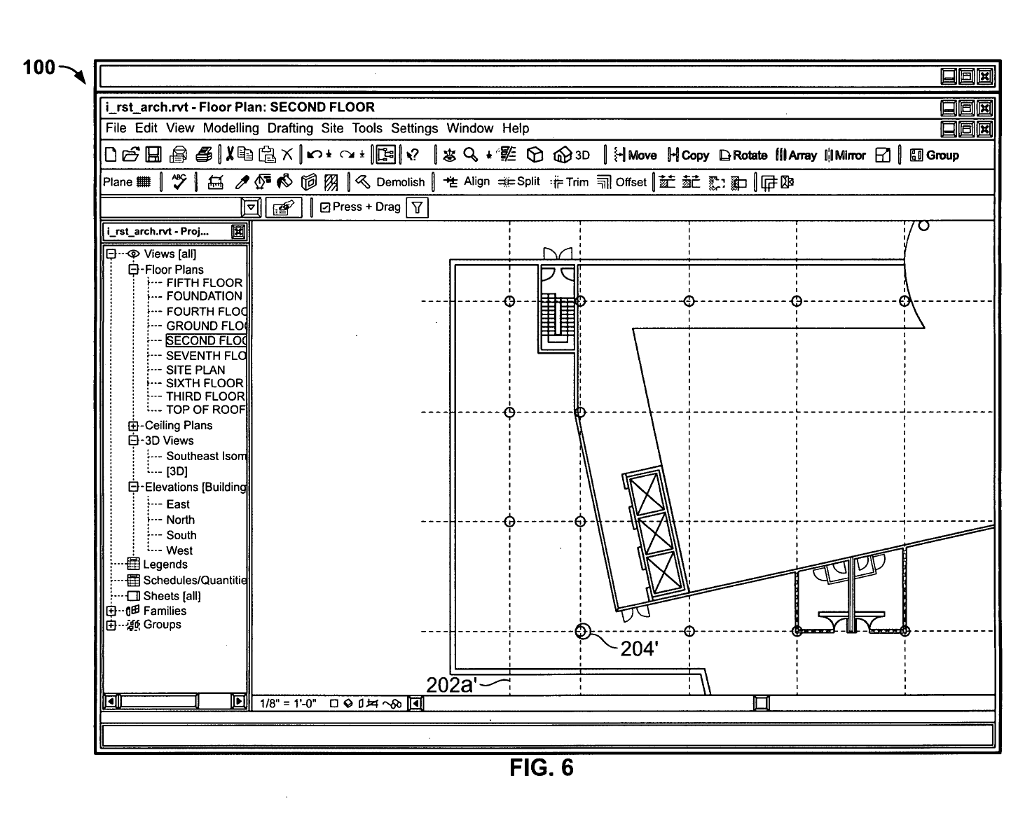

FIG. 6 shows the user interface 100 displaying a corresponding model to that illustrated in the plan view of FIG. 2. For instance, the model depicted in FIG. 2 could be an architectural model whereas the model depicted in FIG. 6 could be a structural model of the architectural model. In this illustration, grid line element 202a′ in the model of FIG. 6 has a monitored relationship with element 202a in the model of FIG. 2. Likewise, column 204′ in FIG. 6 has a monitored relationship with column 204 of FIG. 2. In the illustrations which follow, the changes to the properties of 202a′ and 204′ result in violations of monitored relationships. Notice, also, that a column corresponding to 206 in FIG. 2 is not present in FIG. 6. This is because the column 206′ has been deleted in FIG. 6, thus violating any monitored relationships that may have existed.

In one implementation, a user is notified of violations of monitored relationships as they arise. For example, if a user moves a wall where a monitored relationship for the wall requires its position be equal to corresponding wall in another model, the user can be notified by user interface 100 of the violation. Alternatively, or in addition to, the user can utilize a tool for reviewing all violations in a given model.

FIG. 7 shows a coordination tool 700 for a user of a model containing elements associated with those in the model presented in FIG. 6. The coordination tool 700 allows a user to review all violated relationships for elements in give model (the “current” model). In one implementation, property changes result in a violation as described in TABLE 2.

TABLE 2
VIOLATION DESCRIPTION

| | |
|---|---|
| 1 | Element is changed in another model so that it violates |
| | monitored relationship in current model. |
| 2 | Element is changed in current model so that it violates |
| | monitored relationship in another model. |
| 3 | Corresponding elements are changed in both models |
| | resulting in a violated monitored relationship. |
| 4 | Monitored element is deleted in another model, violating |
| | monitored relationship in current model. |
| 5 | New element is created in another model, and according |
| | to settings it must have a corresponding element in |
| | current model. For example, if a wall of a certain type |
| | is created in a first model and should be copied to a |
| | second model, this violation is triggered. By way of a |
| | further example, assume there is a monitored relationship |
| | between a wall in a first model and a wall in a second |
| | model that requires changes made to the wall in the first |
| | model be reflected the second model's wall. So, if an |
| | insert or opening is added to the wall in the first model, |
| | a violation will be raised if the insert or opening is not |
| | present in the second model's wall. |
| 6 | An element in the current model that is monitored by |
| | another model is deleted. |

The coordination tool 700 can be used simultaneously with user interface 100 and includes a pane 712 for displaying violations of monitored relationships. In one implementation, violations can be categorized and sorted according to various criteria, such as by element and violation type, or by priority. For example, the currently selected violation 710 indicates that a grid has been moved under the violation type of “maintain relative position of Grids,” which is under the element category for grids. The violations presented in pane 712 can also be filtered to show or exclude postponed, rejected and suppressed conflicts 706. (See TABLE 3, below.)

In one implementation, both elements in the monitored relationship are highlighted and presented concurrently, as shown in FIG. 7. Grid line 202a which belongs to a different model is presented alongside its corresponding grid line 202a′ in the current model. In this way, a user is able to immediately detect any noticeable changes, such as the change in location of 202a′. In this example, moving the grid line 202a′ in the current model from its original position (where 202a is) violates a relationship requiring the position properties of the gridlines to be equal.

A user is given options for resolving the currently selected violation (e.g., as shown in pull down menu 708). In one implementation, the options are as described in TABLE 3.

TABLE 3

| VIOLATION | |
|---|---|
| ACTION | DESCRIPTION |
| Postpone | Postpone resolution of the violation; the user can mark |
| | the violation as one requiring the other discipline to |
| | remedy and optionally leave a remark for others to |
| | consider in comment section 714. |
| Reject | Do not incorporate changes to one or more properties of |
| | an element in another model to a corresponding element |
| | in the current model in order to resolve the violation. |
| Accept | Incorporate changes to one or more properties of an |
| difference | element in another model to a corresponding element in |
| | the current model in order to resolve the violation. For |
| | example, if a column is moved in one model and the |
| | column's position is required to be equal to that of |
| | another column in the monitored relationship, the one of |
| | the columns' position will be changed so that their |
| | positions are identical. |
| Suppress | Remove the monitored relationship. |
| Reset | Incorporate changes to one or more properties of an |
| | element in the current model to a corresponding element |
| | in another model in order to resolve the violation. |

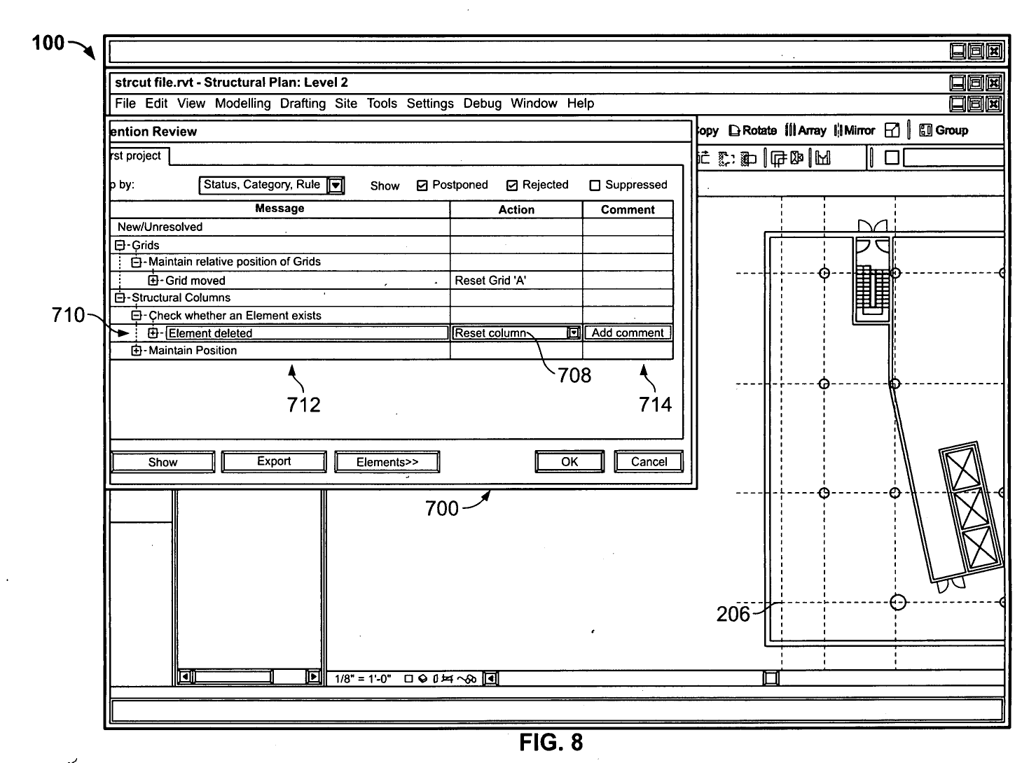

FIG. 8 is a further illustration of the coordination tool 700 for a user of a model containing elements associated with those in the model presented in FIG. 6. The currently selected violation 710 indicates that a column has been deleted under the violation type of “Check whether an Element exists,” which is under the element category for structural columns. Deleting the column element 206′ from the current model violates a relationship requiring both elements to exist. Column 206 which belongs to a different model is presented alongside an empty space corresponding to the column 206′ which was removed from the current model. The user has chosen to action “reset column” 708, which will remove the column 206 from the other model.

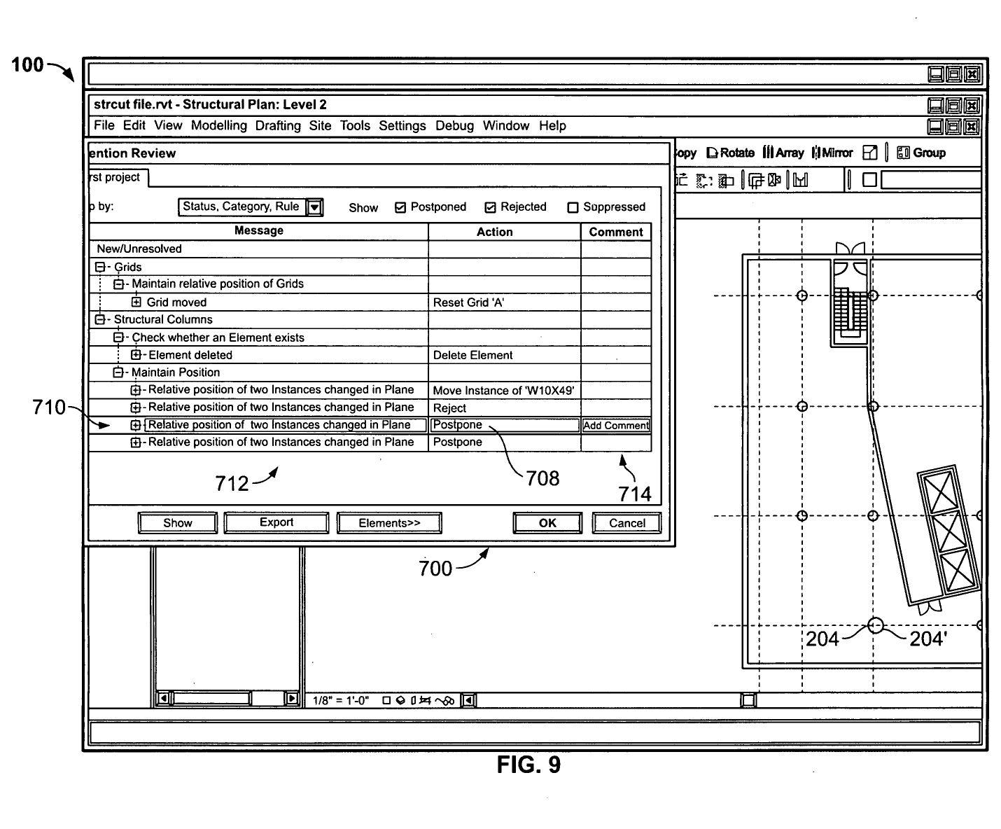

FIG. 9 is a further illustration of the coordination tool 700 for a user of a model containing elements associated with those in the model presented in FIG. 6. The currently selected violation 710 indicates that columns in the two models are no longer in the same position, as required by a monitored relationship. Column 204 which belongs to a different model is presented alongside column 204′ which was removed from the current model. The user has chosen to action “postpone” 708, which will postpone resolution of the violation for another time.

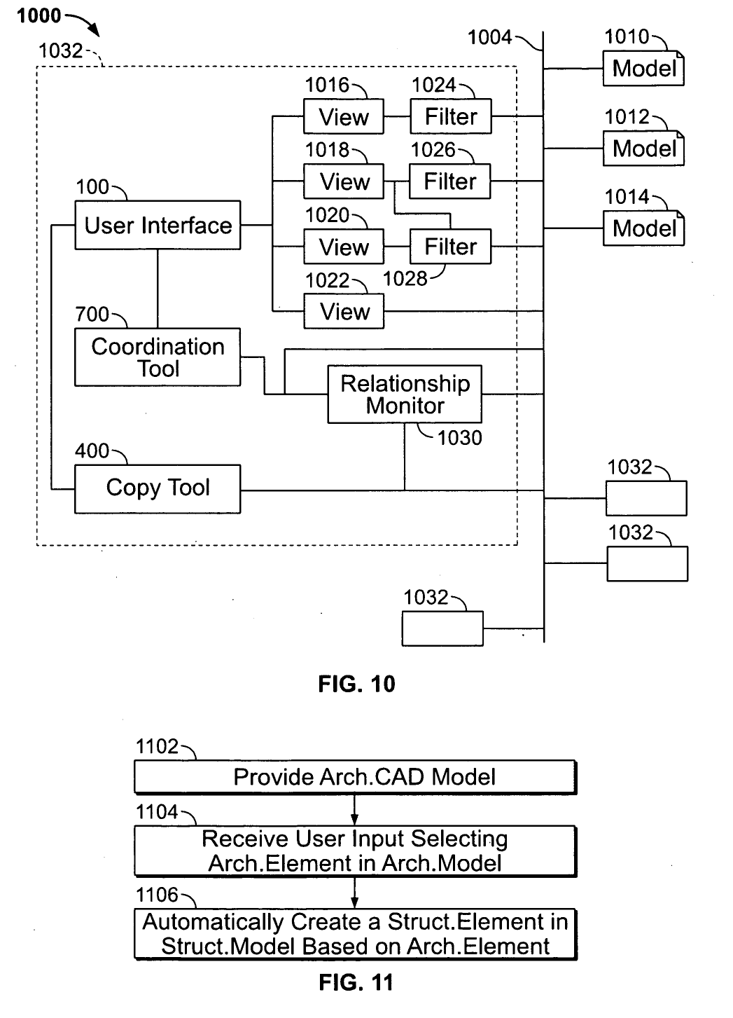

FIG. 10 is a diagram of an interactive system 1000 for synchronizing architectural and structural CAD models. The user interface 100 provides one or more views 1016, 1018, 1020, and 1022 of one or more CAD models 1010, 1012, and 1014. The CAD models are accessible through communication means 1004 which can include one or more wired or wireless computer networks, such as the Internet or an intranet. Generally speaking, a view can present n-dimensions (e.g., 2D, 3D) of information pertaining to the one or more CAD models. Views can be scaled, rotated and translated. CAD model elements can be copied or moved from one view to another. Views can present different aspects of the same CAD model, or combine aspects from more than one CAD model. For example, a view can present elements from both a structural model and an architectural model in the same presentation.

A view can optionally present an altered version of a CAD model by applying one or more filters 1024, 1026, and 1028 to the CAD model. A filter can screen out certain types of information that are of no interest to a given view. For example, a structural view can use a filter to screen out architectural elements, whereas a purely architectural view can use a filter to screen out structural elements. Alternatively, a filter can interact with elements in the CAD model in order to obtain specific representations of the element. For example, an element could render itself as a solid or a wire frame. The user interface 100 propagates information pertaining to changes the user makes the one or more CAD models 1010, 1012 and 1014 through the one or more views 1016, 1018, 1020 and 1022. Changes made in one view that affect other views are reflected in the other views.

The interactive copy tool 400 provides users with the ability to copy elements from one model to another and to establish monitored relationships between the elements, as described above. The copy tool 400 utilizes a relationship monitor component 1030 to establish relationships between associated elements. The relationship monitor 1030 establishes and monitors relationships between associated elements. The relationship monitor 1030 can determine if a relationship holds or if it is violated by examining properties of associated elements in one or more of the CAD models 1010, 1012, and 1014.

In one implementation, information describing relationships is stored in the models 1010, 1012 and 1014. For example, each model can incorporate a table which lists the associations the model's elements belong to. For each association in the table, the corresponding element in another model can be identified, an indication of whether the relationship is unidirectional or bidirectional can be included, as well as the property or properties involved in the relationship, and the type of relationship. In another implementation, relationship information can be persisted outside of the models in a file or a database.

The coordination tool 700 provides users with the ability to review and resolve violated relationships, as described above. The coordination tool 700 utilizes the relationship monitor 1030 to obtain a set of violations pertaining to a user's current model. If a user decides to resolve a given violation by accepting the difference or resetting an element (See TABLE 3), the relationship monitor 1030 determines which property or properties of one or both associated elements need to be modified and modifies them accordingly so that the violation is resolved. The relationship monitor 1030 can operate in the background or on demand, when users or the system need to identify violations. The user is not required to determine how properties need to be changed—this is handled automatically by the relationship monitor 1030 based on the type of relationship.

The user interface 100, coordination tool 700, copy tool 400, views, filters and relationship monitor 1030 make up a CAD application 1032. There can be more than one instance of a CAD application 1032 as illustrated. Each CAD application 1032 can share models simultaneously or use models exclusive of other CAD applications 1032. In one implementation, the CAD applications 1032 can access the CAD model(s) through communication means 1004. In another implementation, the CAD applications 1032 can work with local copies of the CAD models.

The system 1000 may have fewer or more components than those illustrated in FIG. 10. A given component can execute on one or more communicably coupled computing devices. For instance, computing devices can be connected by a wired network, a wireless network, the Internet, shared memory, an inter-processor communication channel, or combinations of these.

FIG. 11 is a flow diagram illustrating automatic creation of structural elements. An architectural CAD model is provided (step 1102). User input is received selecting an architectural element in the architectural CAD model (step 1104). A structural element in a structural CAD model is automatically created (step 1106) based on the selected architectural element. In one implementation, this can be accomplished through use of the copy tool 400, as described above.

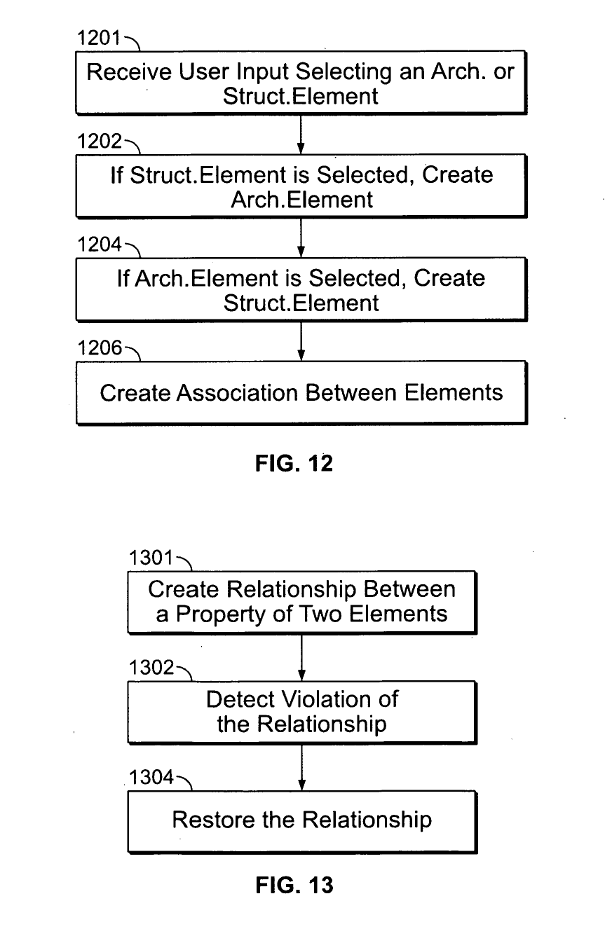

FIG. 12 is a flow diagram illustrating automatic creation of structural elements. A user input is received selecting one of: an architectural element or a structural element (step 1201). If an architectural element is selected, a structural element is created corresponding to the selected architectural element (step 1202). Otherwise, if a structural element is selected, an architectural element is created corresponding to the selected structural element (step 1204). An association is automatically created between the structural element and the architectural element such that a monitored relationship exists between structural element and the architectural element (step 1206). In one implementation, this can be accomplished using the copy tool 400, as described above.

FIG. 13 is a flow diagram illustrating relationship management between CAD models or views. A relationship is created between a first property of a first element in a first CAD model and a second property of a second element in a second CAD model (step 1301). A violation of the relationship is detected, the violation due to modification of one of the first property or the second property (step 1302). One of the first property or the second property is automatically modified to restore the relationship (step 1304). In one implementation, this can be accomplished using the coordination tool 700, as described above.

Although a graphical user interface (GUI) is illustrated, other user interfaces are possible, including user interfaces that allow for user interaction by means of sound, voice, gesture, eye movement, use of remote control devices, manually controlled devices, and combinations of these. The user interface can be provided on a number of computing devices including, but not limited to, devices such as a workstations, personal computers, cellular telephones, personal digital assistants, portable video playback devices, combinations of these, and other suitable devices. In one implementation, the user interface can be presented as one or more web pages.

By way of illustration, the CAD tool can execute on one or more computing devices connected by one or more wired or wireless networks, shared memory, inter-processor networks, or other suitable means. A computing device can run a proprietary or commercially available multi-tasking operating system such as, without limitation, Microsoft Windows® XP (available from Microsoft Corp. of Redmond, Wash.), Linux (available from www.lixux.org), and Apple OS X (available from Apple Computer, Inc. of Cupertino, Calif.).

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device, medium, or in a propagated signal, for execution by, or to control the operation of, data processing apparatus, e.g., a programmable processor, a computer, or multiple computers.

A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

A number of implementation of the invention have been described. Nevertheless, it will be understood that various modifications may be made without departing from the spirit and scope of the invention. For example, the steps of the invention can be performed in a different order and still achieve desirable results. Accordingly, other implementations are within the scope of the following claims.

What is claimed is:

1. A computer-implemented method, comprising:
providing an architectural computer aided design (CAD) model;
receiving a user input selecting an architectural element in the architectural CAD model;
automatically creating a structural element in a structural CAD model, the structural element based on the selected architectural element; and
automatically establishing a monitored relationship between the architectural element and the structural element.

2. The method of claim 1, where:
an architectural element is a wall, a floor, a column, a level, or a grid.

3. The method of claim 1, further comprising:
automatically determining that the monitored relationship is violated.

4. The method of claim 1, further comprising:
allowing a user to resolve the monitored relationship if the monitored relationship is violated.

5. The method of claim 1, further comprising:
automatically resolving the monitored relationship if the monitored relationship is violated.

6. The method of claim 1, where:
the structural element includes a modification of one or more properties of the architectural element.

7. The method of claim 6, where:
the modification is one or more of: modifying a name of the architectural element, subdividing the architectural element, changing a type of the architectural element, or adding an offset to the position of the architectural element.

8. The method of claim 1, where:
creating the structural element includes creating the structural element at a location in the structural model that corresponds to a location in the architectural model.

9. The method of claim 1, where:
the architectural CAD model and the structural CAD model are part of a common CAD model.

10. A computer-implemented method, comprising:
receiving a user input selecting one of: an architectural element or a structural element;
if an architectural element is selected, creating a structural element corresponding to the selected architectural element;
if a structural element is selected, creating an architectural element corresponding to the selected structural element;
automatically creating an association between the structural element and the architectural element such that a monitored relationship exists between structural element and the architectural element; and
monitoring the monitored relationship.

11. The method of claim 10, further comprising:
automatically determining that the monitored relationship is violated.

12. The method of claim 10, where:
automatically resolving the monitored relationship if the monitored relationship is violated.

13. The method of claim 10, further comprising:
modifying a property of one of the structural element and the architectural in accordance to user input; and
updating the property of the other to reflect the modifying.

14. The method of claim 13, where:
updating the property maintains the monitored relationship.

15. A computer-implemented method, comprising:
creating a relationship between a first property of a first element in a first computer aided design (CAD) model and a second property of a second element in a second CAD model;
detecting violation of the relationship, the violation due to modification of one of the first property or the second property; and
automatically modifying one of the first property or the second property to restore the relationship.

16. The method of claim 15, where:
the relationships requires that the first property be equal to the second property.

17. The method of claim 15, where:
updating the structural element includes incorporating the geometry of the surface into the structural element.

18. A computer program product, encoded on an information carrier, comprising instructions operable to cause a data processing apparatus to perform:
providing an architectural computer aided design (CAD) model;
receiving a user input selecting an architectural element in the architectural CAD model;
automatically creating a structural element in a structural CAD model, the structural element based on the selected architectural element; and
automatically establishing a monitored relationship between the architectural element and the structural element.

19. The computer program product of claim 1, further comprising instructions operable to cause the data processing apparatus to perform:
automatically determining that the monitored relationship is violated.
